(19) United States
(12) Patent Application Publication
(10) Pub. No.: US 2009/0037700 A1
(43) Pub. Date: Feb. 5, 2009

(54) Method and system for reactively assigning computational threads of control between processors

(75) Inventor: Martin Gregory Graham, Samford (AU)

Correspondence Address: H. JAY SPIEGEL - H. JAY SPIEGEL & ASSOCIATES, P.O. BOX 11, MOUNT VERNON, VA, 22121, US

(73) Assignee: Clear Falls PTY LTD

(21) Appl. No.: 12/219,876

(22) Filed: Jul. 30, 2008

(30) Foreign Application Priority Data
Jul. 30, 2007 (AU) 2007904048
Nov. 7, 2007 (AU) 2007906186

(51) Int. Cl. G06F 9/30

(52) U.S. Cl. 712/220; 712/E09.016

(57) ABSTRACT

A method and system for reactively assigning computational threads of control between processors provide a coordination model implemented by a software framework. The coordination model comprises five (5) entities which implement the three elements of a coordination model: 1) Behavior, 2) Data, 3) Container, 4) Source and 5) Processor. The invention decomposes an application into a cooperative collection of distributed and networked Behaviors, which are subsequently executed by Containers. A designer using this invention implements a Behavior for each logical stage of execution, which represents the core service-processing logic for that stage.

### BACKGROUND OF THE INVENTION

The present invention relates to a method and system for reactively assigning computational threads of control between processors.

The prior art is derived from known implementations of event-driven and data-driven coordination models. Coordination is defined as the methods and tools that allow several computational entities to cooperate toward a common goal. In the context of this invention, coordination refers to the reactive assignment of computational threads of control between processors, where common goals may include increased utilization of available processing time. A coordination model provides a framework to organize this cooperation, by defining three elements: a) the coordination entities whose cooperation is being organized, eg: processes, threads, various forms of “agents”; b) the coordination media through which the entities communicate, eg: messages, shared variables; and c) the coordination rules, which define the interaction primitives and patterns used by the cooperating entities to achieve coordination. In other words a coordination model can be thought of as the glue that binds computational activities into an ensemble.

Relevant categories and implementations of prior art are:
1. Event-driven Models, JEDI, ELVIN and SEDA, and
2. Data-driven Models, Linda, LIMBO, LIME, Sun Microsystems JavaSpaces, IBM T-Spaces, ObjectSpaces, GigaSpaces.

Herein, Applicant draws upon the coordination rules of “Generative Communications”. Generative communication is an alternative to the traditional message queue-based concurrency model. Generative communication as defined by Gelernter 1980 (G. Gelernter, “/Generative Communication in Linda/”, ACM Transactions on Programming Languages and Systems 7(1), 80-112 (1985)) refers to interacting computational entities that ‘do not exchange messages directly’, but through a coordinating medium which is a shared associative memory, wherein data exchanges through this memory are performed based upon ‘read’, ‘write’ and ‘take’ semantics, which are otherwise known by the terms of ‘out’, ‘in’ and ‘read’ in the literature. Many implementations of generative communications exist, some of which are noted above.

In generative communications, coordinating entities can concurrently insert (or generate) data into the shared memory, while others can withdraw data from the shared memory. The process of inserting data is referred to as a ‘write’ operation. The action of withdrawing data, referred to as a ‘read’ or a ‘take’ operation, uses associative matching of the data and the shared associative memory. The ‘read’ and ‘take’ operations are defined as being non-deterministic in that the identity data return is not determinable prior to the operation being completed. The operations of ‘read’ and ‘take’ differ in that a ‘read’ makes a copy of the data resident in memory, while the ‘take’ makes a copy of the data and removes original data from memory. Interaction through generative communication inherently uncouples communicating entities.

The advantage of generative communications is that a writer/sender of data does not directly contact another coordinating entity, and a reader (or taker) only contacts the shared memory when it actually requires the data, and therefore does not have to strongly couple to other coordinating entities. Due to temporal decoupling, the reader (or taker) does not have to exist at all during the time of generation. This means that sender and receiver can be uncoupled both spatially and temporally, which is in contrast to most distributed languages which are only partially uncoupled in space, and not at all in time. This leads to the major advantage of generative communication: coordinating entities are able to communicate although they are ‘anonymous’ to each other. The two key characteristics of 1) uncoupled and 2) anonymous communication style directly contribute to the design of parallel and distributed applications: uncoupled communication allows abstracting from the details (such as identification and interface) of the entities that are interacting.

The prior art presents a number of problems particularly in the area of reactively assigning computational threads of control between processors:
1. First that coordination rules are primarily a-priori based rules. That is, rules for coordination of entity computational activities and interactions are specified within the model prior to run-time.
2. Second that software based on these coordination models is unable to leverage full capabilities at run-time of processors as the a-priori construction of coordination rules limits the ability of making accurate predictions of necessary structure and behavior at run-time of applications.
3. Third that coordination models cannot make accurate adaptive changes to activities and interactions due to insufficient a-priori information of possible future operating conditions.
4. Fourth that the coordination rules are not appropriately reactive to operating conditions, that is, they are based upon a-priori knowledge of the system when operating.
5. Fifth that the coordinating entities are static and inflexible to reactive change with respect to operating conditions.
6. Sixth that the coordinating media are static and centralized and are inflexible to reactive change to operating conditions.

### SUMMARY OF THE INVENTION

The present invention concerns a method and system for reactively assigning computational threads of control between processors. In particular this invention provides a coordination model implemented by a software framework. The coordination model comprises five (5) entities which implement the three previously defined elements of a coordination model:

1) Behavior entities are the computational threads of control.

2) Data entities are the result of the execution of a Behavior, that is, are input and/or output subsequent to associated Behavior execution.

3) Container entities are part of the coordinating media, and retrieve, create, execute and store Behavior entities and Data entities that are contained within. In general, a Container is associated with each physical Processor, however Containers are also able to control the instantiation of additional Containers per processor based upon, for example, the blocking status of executing Behaviors.

4) Source entities are part of the coordinating media, and allow for storage and retrieval of Data and Behavior entities and, as such, facilitate communication of: Behavior to Behavior, Behavior to Container and Container to Container through the semantics of generative communications. A Source entity can, for example, be shared associative memory for storage and retrieval of Data and Behavior entities.

5) Processor comprises the physical entity that executes the instructions, some examples are: single computer chip CPU, embedded software core processors, Hyper Threading, homogeneous and heterogeneous Multi-Core processors, Mobile Devices and Embedded Devices.

This invention facilitates decomposition of an application into a cooperative collection of distributed and networked Behaviors, which are subsequently executed by Containers. A designer using this invention implements a Behavior for each logical stage of execution, which represents the core service-processing logic for that stage.

As defined, Behavior entities and Data entities are combined and executed by Container entities. In general, a Container performs the following processes:
1) Data-Retrieval: retrieves Data entities;
2) Data-Behavior-Mapping: maps respective Behavior and Data combinations. A Container entity performs this mapping operation through a method referred to here as a ‘Data-Behavior-Mapping’. An example of this mapping occurs in object-oriented terms, where objects have type and objects can be mapped to other objects with respective types and sub-types;
3) Behavior-Retrieval: retrieves the associated Behavior entity from a Source entity;
4) Execution: a Container entity loads and executes the associated Behavior entity. A Container entity passes the Data entity to the executing Behavior entity for processing;
5) Finalization: A result Data entity is returned to the Container entity; and
6) Aggregation: A returned result Data entity is returned to the Container entity for subsequent processing by the Container entity at different points of the process.

This invention provides a mechanism for structuring complex and potentially fragile applications. In this manner, rather than exposing a typed function-call API, Containers leverage this by pulling events of certain types and emitting events of certain types; there need not be a one-to-one matching of event reception and emission, nor any coupling or synchronization both spatially or temporally. The following scenarios represent some examples of implementations of this present invention.

1. Distributed/Networked Processors implement a simple or complex Data-Behavior-Container-Source based application.

2. Homogeneous/Heterogeneous Multi-Core Processors implement a simple or complex Data-Behavior-Container-Source based application.

3. Heterogeneous Multi-Core Processors implement a simple or complex Data-Behavior-Container-Source based application.

4. Microprocessor Architecture which is implemented using Container entities. In short, the Container architecture facilitates decomposition of an application at run-time into a cooperative collection of distributed and networked computational behaviors that communicate through generative communications. In this case, the concurrent system bus communication is facilitated through generative communication implemented through instructions added to the underlying instruction set, implemented by the microprocessor. This could be considered a multi-thread processor.

With reference to the microprocessor architecture implementation, Data (instructions), exceptions and clock I/O are written to the system bus upon input, following which multiple Containers with requisite Behavior decode the input data, and dynamically configure necessary Behavior in order to process or produce data.

### BRIEF DESCRIPTION OF THE DRAWINGS

FIG. 1: A legend for the representation of respective elements depicted in subsequent figures.

FIG. 2: A simple example for a single processor computer, single Container where there exists an input Data (D1) which in this case is a ‘string’, the first Behavior (B1) capitalizes each letter in the string, then outputs the resultant string as D2, subsequently the second Behavior reverses the string.

FIG. 3: A simple example on a two processor computer and two Containers where there exists an input Data (D1) which in this case is a ‘string’, the first Behavior (B1) capitalizes each letter in the string, then outputs the resultant string as D2, subsequently the second Behavior reverses the string.

FIG. 4: Illustrates the structure of an example of Behavior-based service. The service consists of a number of stages for handling network I/O, parsing HTTP requests. Several stages, such as the network and file I/O interfaces, provide generic functionality that could be used by a range of services.

FIG. 5: Illustrates the structure of an example of Behavior-based service. The service consists of a number of stages for handling network I/O, parsing HTTP requests, and so forth. Several stages, such as the network and file I/O interfaces, provide generic functionality that could be used by a range of services.

FIG. 6: Illustrates the process flow for Behavior and Data execution by a Container.

FIG. 7: Illustrates one or more Processors connected via a LAN or WAN network, wherein each Processor may execute one or more Containers as per method.

FIG. 8: Illustrates one or more multi-core Processors, wherein the individual cores of the Processor(s) may execute one or more Containers as per method.

FIG. 9: Illustrates one or more multi-core Processors, wherein the individual cores of the Processor(s) may execute one or more Containers as per method.

FIG. 10: Illustrates a dynamic reconfigurable pipelined multiprocessor System.

### SPECIFIC DESCRIPTION OF PREFERRED EMBODIMENT

The present invention concerns a method and system for reactively assigning computational threads of control between processors. In particular this invention provides a coordination model implemented by a software framework. The coordination model comprises five (5) entities which implement the three previously defined elements of a coordination model:

1) Behavior entities are the computational threads of control, which are executed by a Container entity;

2) Data entities are the result of the execution of a Behavior, that is, are input and/or output to associated Behavior execution;

3) Container entities are part of the coordinating media, and retrieve, create, execute and store Behavior and Data that are contained within. In general, a Container is associated with each physical Processor, however Containers are also able to dynamically control the instantiation of additional Containers per processor based upon, for example, the blocking status of executing Behaviors;

4) Source entities are part of the coordinating media, and allow for storage and retrieval of Data and Behavior entities and as such facilitate communications: Behavior to Behavior, Behavior to Container and Container to Container through the semantics of generative communications. A Source entity can be dynamically connected to by Container(s) and Behavior(s). A Source entity can, for example, be shared associative memory for storage and retrieval of Data and Behavior entities. In addition conceptual a Source entity can be view as a connection between Behavior(s) and Container(s).

5) Processor: comprises the physical entity that executes the instructions, some examples are: single computer chip CPU, embedded software core processors, Hyper Threading, homogeneous and heterogeneous Multi-Core processors, Mobile Devices and Embedded Devices.

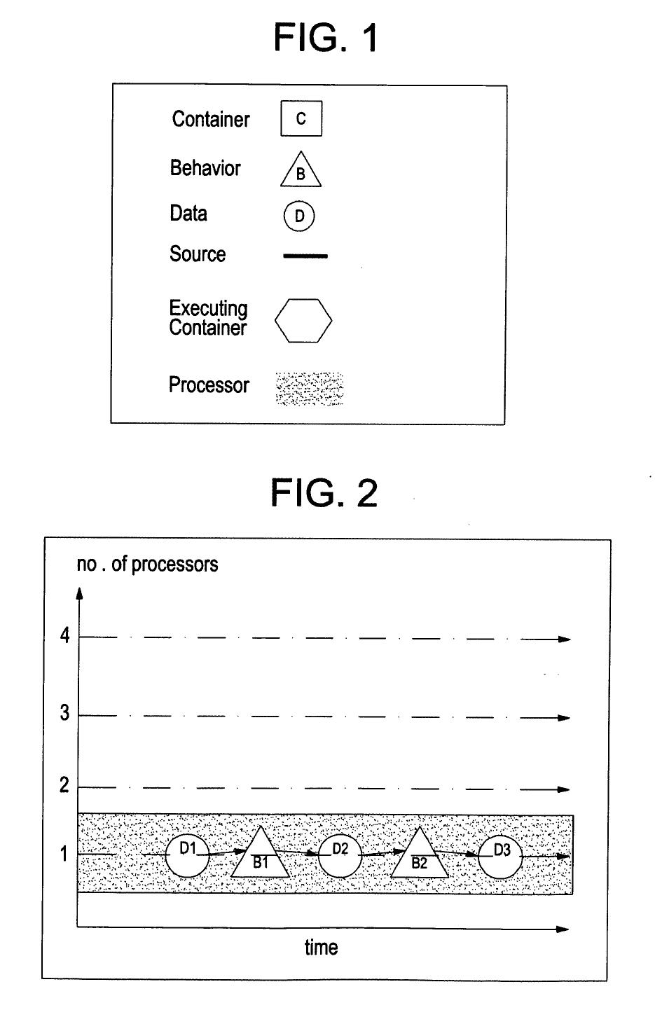

FIG. 1 provides a legend for all subsequent representations and discussions of the described elements.

The combinations of Behavior and Data entities are the basic units of execution in this framework akin to a piece of code that executes in a computer program. Each executing Behavior forms the individual and concurrent flow of control of the overall application, however, unlike the prior art, each Behavior is reactively assigned amongst the Containers which is determined by: 1) current load and 2) resource conditions. This mechanism is managed by the Containers and leverages non-deterministic generative communications.

Containers and Behaviors can communicate external to the system using known communication transports such as for example TCPIP. As such Containers, Behaviors and Data entities are addressable. Internally, communication and interaction is through the use of ‘Source’ entities. Source entities allow for communication which is based upon generative communications. Such communication is derived but not limited by the semantics of ‘read’, ‘write’ and ‘take’ as discussed previously. Source entities are also addressable.

It is highlighted that Behavior and Data are separate entities, which are managed by the Container. However Behavior and Data are related entities. As such, for every Data entity, there will exist zero or more Behavior entities.

Software applications are constructed from the combination of Behaviors associated by their input and output Data as well as respective Source entities. The relationship of Behavior, Data and Source entities form a flow graph, whose nodes are Behavior(s) and edges are Data and Source entities.

Behavior and Data entities may be associated both in short-term and long-term manner. Short-term is defined here as being that there are no blocking operations or looping instructions that occur to allow termination of the Behavior execution. Long-term is defined here as being that no operations occur which do not allow termination.

Applications flow-graph of Behavior(s), Data and Source(s) are decomposed into a cooperative collection of distributed and networked Behaviors and Sources, which are subsequently executed by Containers. A designer using this invention implements a Behavior(s) for each logical stage of execution, which represents the core service-processing logic for that stage.

Behavior(s) and Source(s) can be changed at run-time providing for dynamic reconfiguration of an application. In addition, Containers can substitute alternate Behaviors during run-time based upon localized or remote algorithms.

FIG. 2 represents a simple example on a single Processor, single Container entity, where the dotted line represents the single processor and grey area represents the execution of the Behavior within a Container, and Data being processed. In this example, input Data (D1) which in this case is a ‘string’, the first Behavior (B1) capitalizes each letter in the string, and then outputs the resultant string as D2, subsequently the Behavior (B2) reverses the string, producing Data D3.

In this respect, an application design is based upon separate Behavior and Data entities is referred to here as a control flow, wherein the granularity of the control flow is represented by the staged Behaviors in the flow.

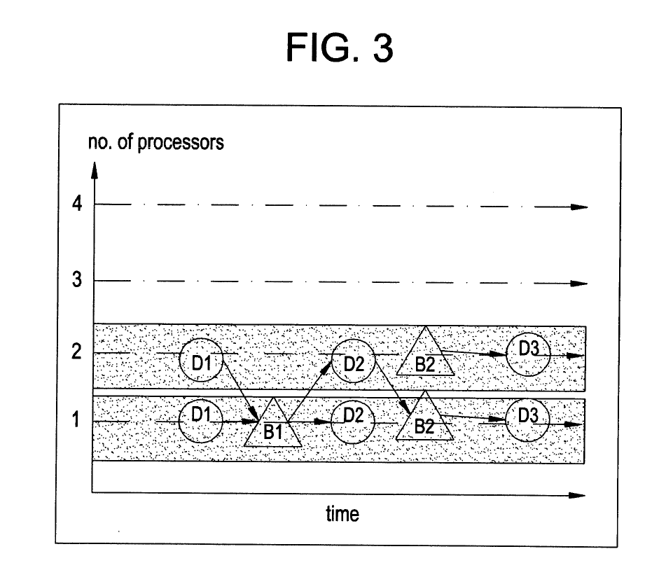

FIG. 3 represents an extension to the simple example of FIG. 2. In this case, there are represented two Processors which can be available for processing, and two Containers, one for each processor.

FIG. 3 represents data and task parallelism inherent in the execution of the Behavior entities and Data entities.

Behaviors as defined here are the entities to be coordinated. In the context of this invention, Behaviors are the computational threads of control which are to be assigned reactively to respective processors, this assignment being represented in the Figure.

A further decomposition into respective Behavior entities and Data entities is demonstrated with respect to a Web Server application. This decomposition could equally be applied to any server architecture in general. A high-level representation of the process flow is shown in the Figure.

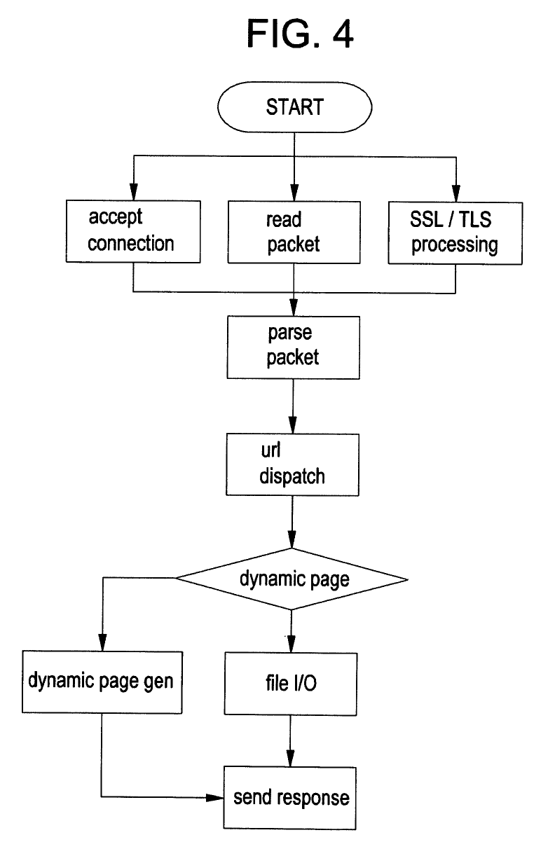

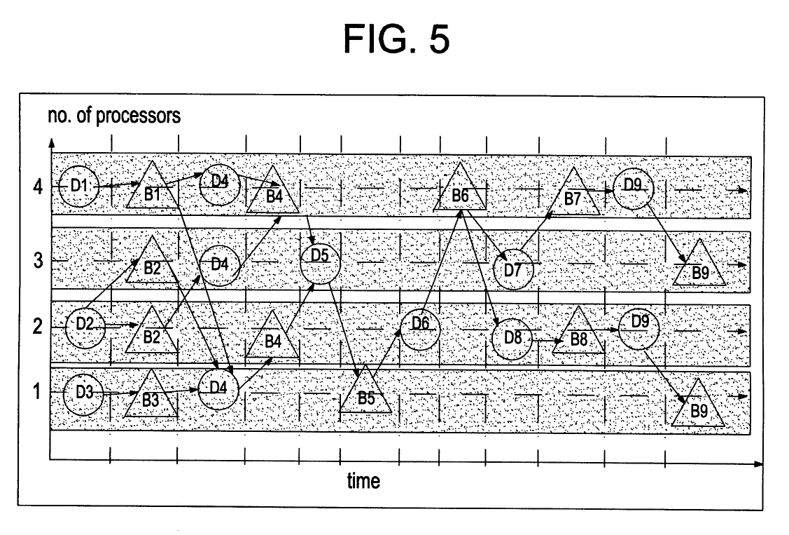

FIG. 5 represents a partial implementation of the FIG. 4 process flow in terms of the Behavior and Data decomposition upon a four processor computer, with four Containers, one for each processor.

In FIG. 5, D1 represents an incoming socket communication connection, which is processed by B1, an ‘accept connection’ Behavior. D2 represents a generic socket packet to be read such as a HTTP request, which is processed by B2, a ‘read packet’ Behavior. D3 represents an SSL/TLS processing request, which is processed by a B3 ‘SSL/TLS request’ Behavior. D4 represents a request packet to be processed, which is processed by B4 ‘parse packet’ Behavior. D5 represents a HTTP packet header, which is processed by a B5 ‘url dispatch’ Behavior. D6 represents ‘HTTP url dispatch request’, which is processed by a B6 ‘dynamic gen conditional’ Behavior. D7 represents a ‘dynamic page generation request’, which is processed by B7 ‘dynamic page generation’ Behavior. D8 represents a ‘static page request’, which is processed by a B8 ‘file I/O’ Behavior which retrieves file from disk storage, and D9 represents a “send response request”, which is processed by B9 ‘send response’ Behavior. It is highlighted in FIG. 5 that there are vertical dashed lines which indicate the time-slicing of events across Processors and Containers. This is significant in respect to this example giving representation of the inherent data and task parallelism that is characteristic of this invention.

As stated, Behavior and Data are separate entities that can be temporally and spatial uncoupled. Behavior and Data are related to each other and their execution environment through the use of a Container and the respective Processor. The following process describes how these systems are composed to form software applications based upon these elements.

In order to build a software application based upon these entities, it is necessary to compose respective Behavior entities and Data entities. Containers are not necessarily a part of the design process. This process is referred to here as composition. An application can be composed at design-time or run-time. In the instance of ‘design-time composition,’ an application can be composed from respective Behavior and Data entities based upon the functionality of the respective Behavior entities and the respective input and output Data entities. This composition can take the form of a flow-graph wherein Behaviors are interconnected via Source entities and respective Data entities. In general, a software tool such as a purpose built graphical user interface integrated development environment, could be used for this purpose to manipulate these elements. However, the important point here is that composition occurs before execution of the particular Behaviors with Data. In the instance of ‘run-time composition,’ the application can be composed dynamically at run-time, that is, the specific mapping between Behavior entities and Data entities are determined only after the application begins executing. The result of which is that systems composed in this manner are dynamically reconfigurable.

In addition, composition may be a combination of design-time and run-time composition where whole or part of the application may be composed at design-time and other whole or parts of the application maybe composed at run-time.

As defined, Behaviors and Data entities are combined and executed by Containers. In general, a Container performs the following processes, as depicted in the Figure:
1) Data-Retrieval: retrieve Data entities,
2) Data-Behavior-Mapping: maps respective Behavior and Data combinations. A Container performs this mapping operation through a method referred to here as a ‘Data-Behavior-Mapping’. An example of this mapping occurs in object-oriented terms, where objects have type and objects can be mapped to other objects with respective types and sub-types.
3) Behavior-Retrieval: retrieves the associated Behavior entity from a Source entity,
4) Execution: a Container entity loads and executes the associated Behavior entity. A Container entity passes the Data entity to the executing Behavior entity for processing,
5) Finalization: A result Data entity is returned to the Container entity.
6) Aggregation: A returned result Data entity is returned to the Container entity for subsequent processing by the Container entity at different points of the process.

A Container entity dynamically at run-time combines associated Behavior entities and Data entities based upon the form of Data-Behavior-Mapping implemented and subsequently executes this combination.

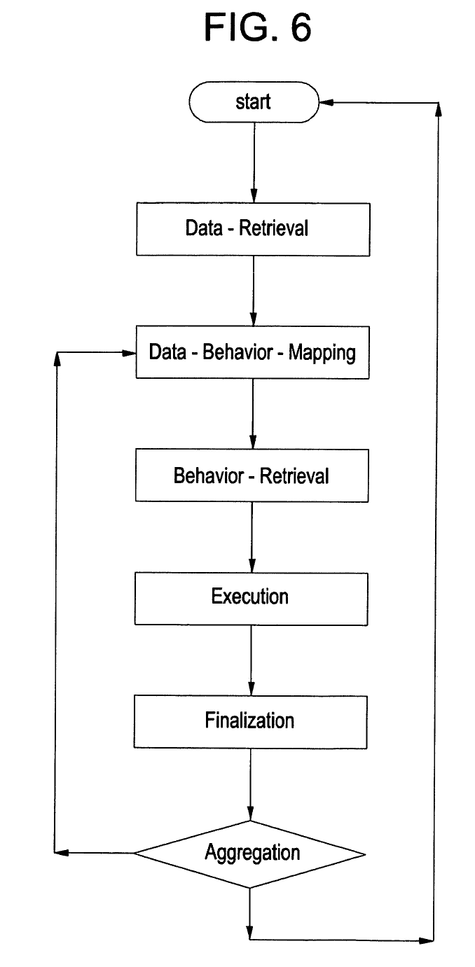

In its simplest embodiment, the process flow shown in FIG. 6 of combination and execution by a Container consists of but is not limited to the following:
1. Data-Retrieval: A Container entity obtains a Data entity from a Source,
2. Data-Behavior-Mapping: A Container entity performs the mapping process for the Data entity,
3. Behavior-Retrieval: A Container entity retrieves the associated Behavior entry from a Source entity,
4. Execution: A Container entity loads and executes the associated Behavior entity. A Container entity passes the Data entity to the executing Behavior entity for processing,
5. Finalization: A result Data entity is returned to the Container entity,
6. Aggregation: A returned result Data entity is returned to the Container entity for subsequent processing by the Container entity.

In regard to the ‘Data-Retrieval’ process, this method employs generative communications. In particular, this method of Data-Retrieval relies upon the non-determinism inherent in the ‘read’ and ‘take’ semantic of generative communications, discussed in the background section, where the Container performs a ‘read’ or ‘take’ operation on a Source entity which could be, for example, shared associative memory. The operation queries for a generic Data entity type, where the type may be, for example, an object-oriented type or XML.

The connected Source entity for Data entities may possess one or more Data types. In addition, a Source entity may possess varying populations of Data entity types. These populations may also vary with time. In this regard, there will be a probability distribution of Data entity types which varies with time.

Subsequently, if a ‘read’ or ‘take’ operation of generative communications using a generic Data type is performed, the frequency of obtaining respective Data entity types over time is governed by the probability distribution of the Data types presented by the Source. That is, there is a variable probability of extracting respective Data types over time. This is a reactive process of Data-Retrieval both internally and externally, which is reactive to the conditions of current Data type and population with time. Variation of Data type and population with time, for example, may be a result of operating conditions such as current work-load or performance of Processors.

In regard to the ‘Data-Behavior-Mapping’ process, this method can be implemented in a form which is centralized, decentralized or both. In the case of centralized, there may exist one or more data structures in memory, such as a table or map, which will allow for a program to perform a search process to identify the respectively mapped Behavior entities. In the case of decentralized, the Data entity has the respectively mapped Behavior type(s) embedded within itself at design-time or run-time, in which case a search process is performed by the Container, in this case inspecting the Data entity for its associated typed Behavior. The Data-Behavior-Mapping process also has reactive characteristics which provide for: 1) dynamic behavior reconfiguration; 2) dynamic variation of granularity of composed Behaviors, that is, the ability for Containers to aggregate Behavior(s) and their execution within a Container; and 3) dynamic substitution of alternative Behavior at run-time.

In regard to the ‘Behavior-Retrieval’ process, this method employs generative communications; in particular, this method of Behavior-Retrieval relies upon the non-determinism inherent in the ‘read’ and/or ‘take’ semantics of generative communications, discussed in the background of the invention. The Container can perform ‘read’ and/or ‘take’ operation on a Source which could be, for example, shared associative memory. This ‘read’ and/or ‘take’ operation queries for a specific Behavior entity type, where the type may be, for example, an object-oriented type or XML. The connected Source for Behavior entities may possess one or more Behavior types. In addition, a Source may possess populations of varying Behavior entity types. These populations may also vary with time. In this regard, there will be a probability distribution of Behavior entity types which varies with time. Subsequently, if a ‘read’ and/or ‘take’ operation of generative communications using a specific Behavior type is performed, the frequency of obtaining respective Behavior entity types over time is governed by the probability distribution of the Behavior types presented by the Source. That is, there can be a variable probability of extracting respective Behavior types over time. This is a reactive process of Behavioral-Retrieval both internally and externally, which is reactive to the conditions of current Data and Behavior type and population with time. Variation of Behavior and Data type and population with time, for example, may be a result of operating conditions such as current work-load or performance of Processors.

In regard to the ‘Execution’ process, this method loads the necessary Behavior instruction code and passes the respective Data entity to an entry point of the Behavior code for subsequent execution.

In regard to the ‘Finalization’ process, this method upon termination of the currently executing Behavior and Data combination will retrieve and store the subsequent Data entity resultant.

In regard to the ‘Aggregation’ process, this method will either return to start, or will proceed to the Data-Behavior-Mapping step, based upon a policy which can be modified for respective circumstances.

There has always existed a significant barrier of complexity of design and construction to building highly distributed and dynamic systems. This invention solves this problem by allowing the design and construction of applications as per traditional methods such as found object-design methodologies.

At run-time, this invention decomposes the application into a cooperative collection of distributed and networked computational behaviors and data that communicate through generative communications. Each executing computational behavior forms the individual and concurrent flow of control of the overall application.

An application is designed and constructed as a logically non-distributed application which makes design conceptualization more effective, but at run-time, the method decomposes and decouples the application into physically distributed entities, which, from the perspective of the Container, appear to interact with the rest of the system by their connected Sources.

An important aspect of processing in this method is that they are inherently subject to admission control. That is, a Container does not merely reject an event in order to implement some resource-management policy, such as preventing response times from growing above a threshold. Containers will by virtue of their pull-based interactions through generative communications only perform the amount of processing they can handle. Therefore, a request is not rejected, but is naturally left for the first available Container to process it. This mechanism acts as an implicit overload signal to applications and can be used by the service to adapt behavior. This mechanism removes the need and complexity of a particular admission control mechanism, which itself depends greatly on the overload management policy and the application itself.

A network of Containers may be constructed either statically (where all stages and connections between them are known at design-time or run-time) or dynamically (allowing stages to be added and removed at run-time). Static network construction allows the designer (or an automated tool) to reason about the correctness of the flow-graph structure; for example, whether the types of Data generated by one Container are actually handled by execution stages downstream from it.

Static construction may also permit compile-time optimizations, such as short-circuiting an event path between two execution stages, effectively combining two execution stages into one and allowing code from one execution stage to be in-lined into another.

Dynamic network construction affords much more flexibility in application design, permitting new execution stages to be added to the system as needed. For example, if some feature of the service is rarely invoked, the corresponding execution stages may only be instantiated on demand. Containers effectively mix both static and dynamic construction. Wherein, at design-time, the various stages and therefore requisite Behaviors are designed and constructed in a-priori fashion. At run-time, the Container architecture dynamically deploys these Behaviors to respective networked Containers, based upon the load and resource conditions at that point in time.

Introducing a container and generative communications between two code modules decouples their execution, providing an explicit control boundary. As well, the execution of a request is not constrained to a given Container, bounding its execution time and resource usage to that consumed within its own execution stage. As a result, the resource consumption of each Container is controlled independently and implicitly, for example, by performing admission control on a stage's incoming Data. An un-trusted, third-party code module can be isolated within its own stage, limiting adverse effects of interference with other stages in the system.

This invention provides a mechanism for structuring complex and potentially fragile applications. In this manner, rather than exposing a typed function-call API, Containers leverage this by pulling events of certain types and emitting events of certain types; there need not be a one-to-one matching of event reception and emission, nor any coupling or synchronization spatially or temporally.

Containers therefore are composed using a form of decentralized protocol, rather than merely type-matching of function arguments and return values, admitting a flexible range of composition policies. For example, a Container can aggregate Behavior across multiple events over time.

Containers also facilitate debugging and performance analysis of services, which have traditionally been challenges in complex application and server environments. Monitoring code can be attached to the entry and exit points of each execution stage, allowing the system designer to profile the flow of events through the system and the performance of each stage. It is also straightforward to interpose proxy stages between components for tracing and debugging purposes.

A key goal of enabling ease of software engineering is to shield programmers from the complexity of performance tuning. In order to keep each stage within its ideal operating regime, Containers makes use of dynamic resource control, automatically adapting the Behavior of each stage based on observed performance and demand. Abstractly, a Container observes runtime characteristics of the stage and implicitly adjusts allocation and scheduling parameters to meet performance targets.

A wide range of resource control mechanisms are possible in the Container implementation. One example is tuning the number of threads executing within each stage. If all operations within a stage are non-blocking, then a stage would require no more than one thread per Processor to handle load. However, given the possibility of short blocking operations, additional threads may be needed to maintain concurrency. Likewise, allocating additional threads to a stage has the effect of giving that stage higher priority than other stages, in the sense that it has more opportunities to execute.

Another example is adjusting the number of Data entities aggregated per Container within each population passed to a stage's Behavior. A large population size allows for increased locality and greater opportunity to amortize operations across multiple Containers, while a small population size localizes and evenly distributes work across multiple Containers in multiple stages.

Dynamic control in Containers allows the application to adapt to changing conditions despite the particular algorithms used by the underlying operating system. In some sense, Containers are naive about the resource management policies of the OS. For example, the Containers thread pool sizing controller is not aware of the OS thread scheduling policy, rather, it influences thread allocation based on external observations of application performance.

Another form of implicit resource management in Containers is overload, control. Here, the goal is to prevent the service from exhibiting significantly degraded performance under heavy load due to over committing resources. As a service approaches saturation, the response times exhibited by requests can grow exponentially. To address this problem, it is often desirable to shed load, for example, by sending explicit rejection messages to users, rather than causing all users to experience unacceptable response times.

Overload protection in Containers can be accomplished through the use of fine-grained and inherent admission control at each stage, as a result of generative communication primitives which can be used to simulate a wide range of policies. Generally, by having inherent admission control, the system can limit the rate at which that stage accepts new Data entities, allowing performance bottlenecks to be isolated. Containers allow the admission control policy to be tailored dynamically for each individual stage, and admission control can be disabled for any stage.

A fundamental property of Container composition design is that stages are prepared to deal with Data rejection. Rejection of events from a Source indicates that the corresponding stage is overloaded, and the Container uses this information to implicitly adapt. This explicit indication of overload differs from traditional service designs that treat overload as an exceptional case for which applications are given little indication or control. In this invention, overload management is a primary characteristic of the run-time dynamics.

Rejection of a Data entity from a Container does not imply that the user's request is rejected from the system. Rather, it is the responsibility of the stage receiving a Data rejection to perform some alternate action. This action depends greatly on the Behavior logic. For example, if a static Web page request is rejected, it is usually sufficient to send an error message to the client indicating that the service is overloaded. However, if the request is for a complex operation such as executing a stock trade, it may be necessary to respond in other ways, such as by transparently re-trying the request at a later time. More generally, Data rejection can be used as a signal to degrade service, by performing variants of a service that require fewer resources.

The following scenarios represent some embodiments of the invention.

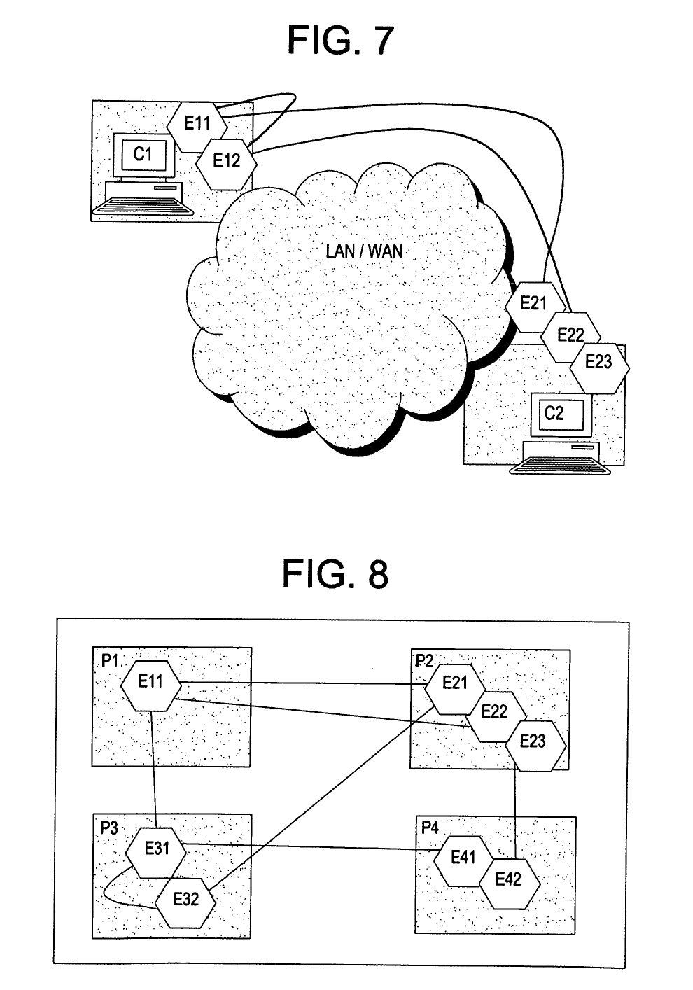

1. Distributed/Networked Processors: The embodiment of FIG. 7 represents a distributed/network of Processors, which implement a simple or complex Data-Behavior-Container-Source based application. The Processors may include: single computer chip CPU, embedded software core processors, Hyper Threading, homogeneous and heterogeneous Multi-Core processors, Mobile Devices and Embedded Devices. In FIG. 7, C1 and C2 represent Processors which are physically connected through a LAN or WAN or both. E11, E12, E21, E22 and E23 represent executing Containers as per the method and system described. This embodiment is an example and is not limited to this number or type of Processors or executing Containers. The Source lines connecting executing Containers represent the interaction and communication of Data entities at run-time between executing Containers and Behaviors.

2. Homogeneous/Heterogeneous Multi-Core Processors: The embodiment of FIG. 8 represents a homogeneous/heterogeneous Multi-core Processor, which implements a simple or complex Data-Behavior-Container-Source based application. In FIG. 8, P1, P2, P3 and P4 represent Processors which maybe either homogeneous or heterogeneous in type. E11, E21, E22, E23, E31, E32, E41 and E42 represent executing Containers as per the method and system described. This embodiment is an example and is not limited to this number or type of Processors or executing Containers. The Source lines connecting executing Containers represent the interaction and communication of Data entities at run-time between executing Containers and Behaviors.

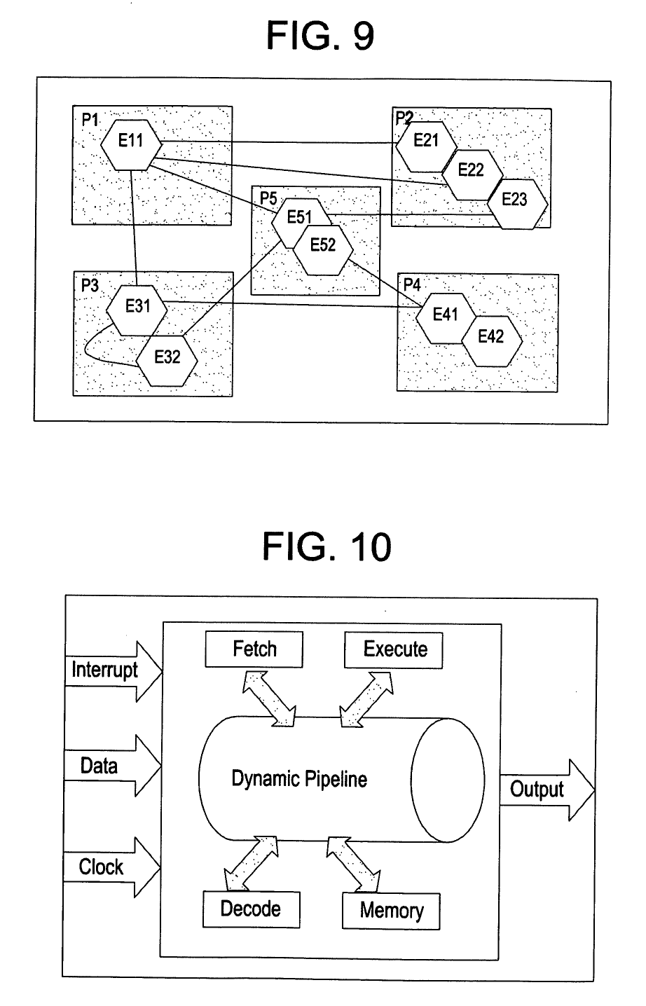

3. Heterogeneous Multi-Core Processors: The embodiment of FIG. 9 represents a heterogeneous Multi-core Processor, which implements a simple or complex Data-Behavior-Container-Source based application. In FIG. 9, P1, P2, P3, P4 and P5 represent Processors which are heterogeneous in type. P5 may act as Master in Master-Slave interaction pattern and P1-P4 may act as Slave Processors. Alternatively, Processors P1-P4 may act as Peers in Peer-To-Peer interaction pattern with P5 acting as a rendezvous point for the interaction. Alternatively, Processors P1-P4 may act as Producers in a Producer-Consumer interaction pattern with P5 acting as a Consumer. Alternatively, Processors P1-P4 may act as Consumers in a Producer-Consumer interaction pattern with P5 acting as a Producer. E11, E21, E22, E23, E31, E32, E41, E42, E42, E51 and E52 represent executing Containers as per the method and system described. This embodiment is an example and is not limited to this number or type of Processors or executing Containers. The Source lines connecting executing Containers represent examples of interaction and communication of Data entities at run-time between executing Containers and Behaviors.

4. Microprocessor Architecture: General purpose software/hardware microprocessor architecture incorporates at least three distinct functions (modules), as follows:
1) Fetch—Fetching the next instruction,
2) Decode—Decoding the fetched instruction and,
3) Execute—Executing the decoded instruction.

These functions are implemented as specific modules within the architecture. Modules within the architecture can be considered to be the actual configuration of the microprocessor at the gate level, which implements the desired method and system of the invention. These modules communicate through single or multiply configured distinct and static system buses.

In addition, the number of Fetch, Decode and Execute modules are also fixed and their location within the microprocessor is static. As well, the particular module behavior or function is static and cannot be changed during operation.

This embodiment includes a microprocessor architecture which is implemented using Containers. A Container-based architecture decomposes an application at run-time into a cooperative collection of distributed and networked computational behaviors and data that communicate through generative communications. In this case, the concurrent system bus communication is facilitated through Source entities, which is implemented through instructions added to the underlying instruction set, implemented by the microprocessor. This Source entity based bus structure can take any network topological form including for example mesh network.

With reference to FIG. 10, Data (instructions), exceptions and clock I/O are written to the system bus upon input, following which embedded Container(s) with requisite Behavior decodes the input data, and dynamically configures necessary Behavior in order to process data.

This architecture has at least the following applications:
1. The hardware implementation of Containers allows for reactive adaptation and self reconfiguration to optimize performance and reduce power consumption and heat dissipation determined by: 1) current load and 2) resource conditions. This mechanism is managed by the Containers.
2. The “dynamic pipeline” of the system bus generated by the interaction of Containers and the resultant output realizes multiple independent and dynamically time varying system buses. Whereas current architectures statically configure these inter-processor communications systems and implemented complex topologies such as superscalar and mesh network buses, this architecture dynamically produces a communication topology “best fit for the current operating conditions at the time”.
3. The dynamic reconfigurable nature of Containers and Behaviors allows for system modules such as the mentioned Fetch, Decode and Execute modules, for example, to be changed during operation. That is a different Behavior, for the Decode module, for instance, may produce the ability to process different instruction sets simultaneously without a-priori design. An example being the provision of dynamic “instruction level virtualization” environment for executing disparate languages based upon for example RISC or CISC to execute concurrently and be able to benefit from the load-sharing and resource management capabilities inherent in the underlying Container architecture upon which this architecture is implemented.
4. The dynamic reconfigurable nature of Containers allows for the respective modules and their interactions to change during run-time, dependent upon current conditions and respective requirements. For instance, this architecture may allow for altogether new modules to be added during operation, which allows for reconfiguration of overall behavior of the microprocessor or allows for reconfiguration to allow for improved performance for minimization of resources such as power and heat production.
5. The dynamic reconfigurable nature of Containers and Behaviors and the reactive coordination foundation of this technology allows for run-time self-reconfiguration of the microprocessor.
6. A self-reconfigurable architecture allows for design-time integration and run-time reconfiguration with a high level “Integrated Development Environment”, through the use of system call-backs and hooks implemented in the Container microprocessor net-list.

As such, an invention has been disclosed in terms of preferred embodiments which fulfill each and every one of the objects of the present invention as set forth hereinabove, and provide a new and useful method and system for reactively assigning computational threads of control between processors of great novelty and utility.

Of course, various changes, modifications and alterations in the teachings of the present invention may be contemplated by those skilled in the art without departing from the intended spirit and scope thereof.

As such, it is intended that the present invention only be limited by the terms of the appended claims.

1. A method including the steps of providing at least one processor and reactively assigning computational threads of control with respect to said at least one processor.

2. The method of claim 1 further including the step of providing Behavior entities comprising said computational threads of control.

3. The method of claim 1 further including the step of providing Data entities resulting from execution of a Behavior entity, said Data entities comprising input and/or output subsequent to associated Behavior entity execution.

4. The method of claim 1 further including the step of providing Container entities as part of coordinating media, and retrieving, creating, executing and storing Behavior entities and Data entities that are contained within said Container entities, a Container entity being associated with each Processor, however, Container entities controlling instantiation of additional Container entities per processor based upon, for example, blocking status of executing Behavior entities.

5. The method of claim 1 further including the step of providing Source entities as part of the coordinating media for allowing for storage and retrieval of Data entities and Behavior entities and, as such, facilitating communication of the following: Behavior entity to Behavior entity, Behavior entity to Container entity, and Container entity to Container entity through semantics of generative communications, a Source entity being dynamically connected to by Container entities and Behavior entities and, a Source entity comprising shared associative memory for storage and retrieval of Data and Behavior entities.

6. The method of claim 1 further comprising that each Behavior entity is reactively assigned among the Container entities which is determined by: 1) current load and 2) resource conditions.

7. The method of claim 6 further comprising the step of reactively assigning Behavior entities between Container entities being managed by the Container entities and leveraging non-deterministic generative communications.

8. The method of claim 1 including the steps of providing Container entities and Behavior entities communicating internally through the use of ‘Source’ entities, said Source entities facilitating communication based upon generative communications including at least ‘read’, ‘write’ and ‘take’ communications.

9. The method of claim 1 further including the steps of providing Behavior entities and Data entities that are separate entities managed by a Container entity.

10. The method of claim 9 further wherein said Behavior and Data entities are related entities, whereby for every Data entity there exists a Behavior entity.

11. The method of claim 1 further wherein applications of each processor are constructed from a combination of Behavior entities associated by their input and output Data entities.

12. The method of claim 10 further wherein Behavior and Data entities may be associated both in short-term and long-term manner.

13. The method of claim 11 further including the step of providing a Behavior entity associated with each logical stage of execution of a Behavior entity representing a core service-processing logic for that stage.

14. The method of claim 3 further wherein said Behavior and Data entities are separate entities able to be temporally and spatial uncoupled.

15. The method of claim 3 further wherein said Behavior and Data entities are related to each other and their execution environment through the use of a Container entity and a respective Processor.

16. The method of claim 15 further including the step of composing an application at a design-time or a run-time of a Processor.

17. The method of claim 16 further including the steps of, in the instance of ‘design-time composition,’ composing an application from respective Behavior and Data entities based upon functionality of respective Behavior entities and respective input and output Data entities, a said composition taking a form of a flow-graph wherein Behavior entities are interconnected via Source entities and respective Data entities.

18. The method of claim 16 further including the step of providing a run-time composition, whereby an application may be composed dynamically at run-time, with specific mapping between Behavior entities and Data entities being determined only after an application begins executing.

19. The method of claim 16 further including the steps of providing a combination of design-time and run-time composition where a whole or part of an application may be composed at design-time and other whole or parts of the application may be composed at run-time.

20. The method of claim 1 further including the step of providing Container entity process flow including 1) Data-Retrieval, 2) Data-Behavior-Mapping, 3) Behavior-Retrieval, 4) Execution, 5) Finalization, and 6) Aggregation.

21. The method of claim 1 further including the step of providing a Container entity dynamically combining at run-time with associated Behavior entity and Data entity based upon a form of Data-Behavior-Mapping implemented and subsequently executing this combination.

22. The method of claim 20 further including the steps of providing a Container entity performing a ‘read’ or ‘take’ operation on a Source entity, this ‘read’ or ‘take’ operation queries for a generic Data entity type, where the type may be an object-oriented type or XML, a connected Source entity for Data entities possessing one or more Data types, a Source entity possessing populations of varying Data entity types, said populations being variable with time.

23. The method of claim 22 further including the steps of providing a probability distribution of Data entity types variable with time, subsequently if a ‘read’ or ‘take’ operation of generative communications using a generic Data type is performed, a frequency of obtaining respective Data entity types over time being governed by a probability distribution of Data types presented by the Source, there being a variable probability of extracting respective Data types over time, comprising a reactive process of Data-Retrieval both internally and externally, reactive to conditions of current Data type and population with time, variation of Data type and population with time being a result of operating conditions such as current work-load or performance of each Processor.

24. The method of claim 20 further including the steps of providing a Data-Behavior-Mapping process implemented in a centralized form, a decentralized form, or both, whereby in the case of the centralized form, there may exist one or more data structures in memory such as a table or map allowing a program to perform a search process to identify respectively mapped Behavior entities, in the case of a decentralized form, the Data entity has respectively mapped Behavior entities embedded within itself at design-time or run-time, in which case a search process is performed by a Container entity inspecting a Data entity for its associated typed Behavior entity, the Data-Behavior-Mapping process also including reactive characteristics providing 1) dynamic behavior reconfiguration, 2) dynamic variation of granularity of composed Behavior entities, namely, the ability for Container entities to aggregate Behavior entities and their execution within a Container entity, and 3) dynamic substitution of alternative Behavior entity at run-time.

25. The method of claim 20 further including the step of providing a Behavior-Retrieval process employing generative communications and relying upon non-determinism inherent in ‘read’ and/or ‘take’ semantics of generative communications, whereby a Container entity may perform a ‘read’ and/or ‘take’ operation on a Source entity including a shared associative memory, said ‘read’ and/or ‘take’ operation querying for a specific Behavior entity type, whereby the type may be, for example, an object-oriented type or XML type, connected Source or Behavior entities may possess one or more Behavior entity types, which a Source may possess populations of varying Behavior entity types, which populations may also vary with time.

26. The method of claim 25 further including the steps of providing a probability distribution of Behavior entity types which varies with time, whereby subsequently, if a ‘read’ and/or ‘take’ operation of generative communications using a specific Behavior type is performed, a frequency of obtaining respective Behavior entity types over time is governed by a probability distribution of the Behavior types presented by a Source entity providing a variable probability of extracting respective Behavior types over time, providing a reactive process of Behavioral-Retrieval both internally and externally, reactive to conditions of current Data and behavior type and population with time, variation of Behavior and Data type and population with time resulting from operating conditions such as current work-load or performance of each Processor.

27. The method of claim 20 further including the step of providing an Execution process loading necessary Behavior instruction code and passing a respective Data entity to an entry point of the code for subsequent execution.

28. The method of claim 20 further including the step of providing a Finalization process upon termination of a currently executing Behavior and Data combination to retrieve and store a subsequent Data entity result.

29. The method of claim 20 further including the step of providing an Aggregation process to either return to start, or proceed to said Data-Behavior-Mapping step, based upon policy modifiable for respective circumstances.

30. The method of claim 1 further including the steps of designing and constructing an application as a logically non-distributed application making design conceptualization more effective, whereas at run-time the method decomposes and decouples the application into physically distributed entities, which from a Container entity perspective appear to interact with the rest of a system by connected Sources.

31. The method of claim 1 further including the steps of providing an inherent characteristic of admission control, a Container entity not merely rejecting an event in order to implement some resource-management policy, such as preventing response times from growing above a threshold, Container entities having pull-based interactions through generative communications so as to only perform an amount of processing they can handle, whereby a request is not rejected but is naturally left for a first available Container entity to process, such mechanism acting as an implicit overload signal to applications and being used by the service to adapt behavior, whereby this mechanism removes the need and complexity of a particular admission control mechanism, which itself depends greatly on the overload management policy and the application itself.

32. The method of claim 1 further including the steps of providing a network of Container entities that may be constructed either statically (where all stages and connections between them are known at design-time or run-time) or dynamically (allowing stages to be added and removed at run-time), static network construction allowing a designer (or an automated tool) to reason about the correctness of a graph structure; for example, whether types of Data generated by one Container entity actually handled by execution stages downstream from it.

33. The method of claim 32 further including the step of permitting compile-time optimizations through static construction, such as short-circuiting an event path between two execution stages, effectively combining two execution stages into one and allowing code from one execution stage to be in-lined into another.

34. The method of claim 32 further including the step of providing dynamic network construction affording flexibility in application design, permitting new execution stages to be added to the system as needed, Container entities effectively mixing both static and dynamic construction, wherein at design-time, various stages and therefore requisite Behavior entities are designed and constructed in a-priori fashion and at run-time, Container architecture dynamically deploys these Behavior entities to respective networked Container entities, based upon load and resource conditions at that point in time.

35. The method of claim 1 further including the steps of providing Container entities introducing a Container entity and generative communications between two code modules and decoupling their execution, providing an explicit control boundary as well as execution of a request not being constrained to a given Container entity, bounding its execution time and resource usage to that consumed within its own execution stage, whereby resource consumption of each Container entity is controlled independently and implicitly, for example, by performing admission control on a stage's incoming Data entity, an un-trusted, third-party code module being isolated within its own stage, thereby limiting adverse effects of interference with other stages in the system.

36. The method of claim 1 further including the step of providing ability for structuring complex and potentially fragile applications, by pulling events of certain types and emitting events of certain types using Container entities without any coupling or synchronization either spatially or temporally.

37. The method of claim 1 further including the steps of providing that Container entities facilitate debugging and performance analysis of services, monitoring code being attached to entry and exit points of each execution stage, thereby allowing a system designer to profile flow of events through the system and performance of each stage, Container entities having proxy stages interposed between components for tracing and debugging purposes.

38. The method of claim 1 further including the steps of providing that Container entities make use of dynamic resource control, automatically adapting behavior of each stage based on observed performance and demand, a Container entity observing runtime characteristics of the stage and implicitly adjusting allocation and scheduling parameters to meet performance targets.

39. The method of claim 1 further including the steps of providing adjustment of a number of Data entities aggregated per Container entity within each population passed to a stage's behavior, a large population size allowing for increased locality and greater opportunity to amortize operations across multiple Container entities, while a small population size localizing and evenly distributing work across multiple Containers in multiple stages.

40. The method of claim 1 further including the step of providing dynamic control in Container entities allowing an application to adapt to changing conditions despite particular algorithms used by an underlying operating system.

41. The method of claim 1 further including the steps of providing Container entity overload control, where a goal is to prevent a service from exhibiting significantly degraded performance under heavy load due to over committing of resources, overload protection in Container entities being accomplished through use of fine-grained and inherent admission control at each stage, as a result of generative communication primitives which can be used to simulate a wide range of policies, the system limiting a rate at which that stage accepts new Data entities, allowing performance bottlenecks to be isolated, Container entities allowing the admission control policy to be tailored dynamically for each individual stage, and admission control being disabled for any stage.

42. A system of processors, comprising a plurality of processors and computational threads of control provided between said processors, said computational threads of control comprising at least one Behavior entity.

43. The system of claim 42, wherein said at least one Behavior entity is contained within a Container entity.

44. The system of claim 43, wherein said Container entity also contains at least one Data entity connected to said at least one Behavior entity, said at least one Data entity resulting from execution of a Behavior entity.

45. The system of claim 44, further including at least one Source entity for storage and retrieval of Data entities and Behavior entities.

46. The system of claim 45, wherein said Source entity permits communication between Behavior entities.

47. The system of claim 46, wherein said Source entity permits communication between Container entities.

48. The system of claim 47, wherein said Source entity permits communication between a Behavior entity and a Container entity.

49. The system of claim 45, wherein said Source entity permits communication between Container entities.

50. The system of claim 45, wherein said Source entity permits communication between a Behavior entity and a Container entity.

51. The system of claim 45, wherein said at least one Source entity is addressable.

52. The system of claim 44, wherein said Container entity, Behavior entity and Data entity are addressable.

53. The system of claim 42, wherein said processors comprise homogeneous/heterogeneous multi-core processors.

54. The system of claim 42, wherein said Behavior entity is re-configurable.

55. The system of claim 43, wherein said Container entity is re-configurable.

56. The system of claim 54, wherein said Container entity is re-configurable.
